(19) United States
(12) Patent Application Publication
(10) Pub. No.: US 2010/0275197 A1
(43) Pub. Date: Oct. 28, 2010

(54) COMPUTER READABLE STORAGE MEDIUM FOR INSTALLING A PROGRAM

(75) Inventor: Tomoki NAKAMURA, Aichi (JP)

Correspondence Address: Scully, Scott, Murphy & Presser, P.C., 400 Garden City Plaza, Suite 300, Garden City, NY, 11530, US

(73) Assignee: BROTHER KOGYO KABUSHIKI KAISHA, Aichi (JP)

(21) Appl. No.: 12/731,765

(22) Filed: Mar. 25, 2010

(30) Foreign Application Priority Data
Apr. 23, 2009 (JP) 2009-105736

(51) Int. Cl. G06F 9/445

(52) U.S. Cl. 717/174

(57) ABSTRACT

A computer readable storage medium storing computer readable instructions is provided. The computer readable instructions manipulate a computer to install a computer program by executing steps of installing a computer program in the computer, and registering designating information indicating a location of a content summary information providing site, through which content summary information concerning the computer program is distributed, in an information reader, which is capable of accessing the content summary information based on the registered designating information, obtaining the content summary information and location information concerning information content included in the accessed content summary information, and accessing the information content based on the obtained location information, so that the information reader obtains the content summary information concerning the installed computer program based on the registered designating information.

### CROSS REFERENCE TO RELATED APPLICATION

This application claims priority from Japanese Patent Application No. 2009-105736, filed on Apr. 23, 2009, the entire subject matter of which is incorporated herein by reference.

### BACKGROUND

1. Technical Field

An aspect of the present invention relates to a computer readable storage medium to control a computer to install a computer program.

2. Related Art

Various kinds of data contents are provided openly to computer users, and the users can download to utilize the data contents through networks, such as the Internet. The data contents include software programs to be downloaded to aid remotely a computer user when the user sets up a personal computer (PC) or handles errors occurring in the PC. For example, a user supporting system to support the user through the networks, in which the PC is provided with a configuration obtaining program to extract software and hardware configuration of the PC downloading the program and transmit the configuration information to the server, is provided. The server generates supporting information based on the received configuration information and inquiries and provides the generated supporting information to the PC through, for example, telephones, facsimile transmission, e-mails, and web sites.

For another example, an installer program to aid the user to install a device driver in the PC is provided. The installer program contains an HTML data file, which includes information indicating a location address of the supporting information for the device, and installation of the device driver includes storing the HTML file in the PC and placing a shortcut icon linked to the HTML file in a data folder representing a desktop of the PC so that the user can access the supporting information through the shortcut icon and through the HTML file.

In the computer network environment, a service system utilizing RSS (RDF Site Summary/Really Simple Syndication/Rich Site Summary)-formatted data (RSS data) is provided. The RSS data includes information concerning summaries and updates of information contents provided through a predetermined web site on the Internet. The RSS data can be distributed to designated users by use of RSS reader software so that the users can recognize the updates concerning the information contents on a timely basis without voluntarily accessing the web site.

### SUMMARY

When computer programs are provided through a web site of a supplier of the computer programs, the web site may publish information concerning the computer programs and the supplier itself.

For example, when the computer program to be installed in a PC is updated, a notice concerning the update is published through the web site of the supplier of the program for users to view. The users access the web site of the supplier by use of web browsers, which are installed in the PCs having the computer program to be updated installed, and downloads the updated program to execute the updated program in the PCs. Thereby the existing computer program is updated.

The present invention is advantageous in that a technique to provide information concerning a newly installed and updated computer program to a user is provided.

According to an aspect of the present invention, a computer readable storage medium storing computer readable instructions is provided. The computer readable instructions manipulate a computer to install a computer program by executing steps of installing a computer program in the computer, and registering designating information indicating a location of a content summary information providing site, through which content summary information concerning the computer program is distributed, in an information reader, which is capable of accessing the content summary information based on the registered designating information, obtaining the content summary information and location information concerning information content included in the accessed content summary information, and accessing the information content based on the obtained location information, so that the information reader obtains the content summary information concerning the installed computer program based on the registered designating information.

According to the above computer readable storage medium, the designating information indicating the location of the content summary information providing site, which distributes the content summary information, can be registered in the information reader installed in the computer upon installation of the computer program. Therefore, the computer can be configured to obtain the content summary information, which may be useful to the computer. The content summary information concerning the computer program includes information directly or indirectly related to the computer program. The information indirectly related to the computer program includes, for example, information concerning a supplier of the computer program. The content summary information obtained by the information reader can be presented to the user to view through, for example, a display device.

According to another aspect of the present invention, a computer readable storage medium storing computer readable instructions is provided. The computer readable instructions manipulate a computer to install a computer program by executing steps of installing a computer program in the computer, judging as to whether an information reader, which is capable of accessing content summary information concerning the computer program based on registered designating information, obtaining location information concerning information content included in the accessed content summary information, and accessing the information content based on the obtained location information, is installed in the computer, registering, when judgment is made that the information reader is installed in the computer, the designating information indicating a location of a content summary information providing site, through which the content summary information is provided to the computer, in the information reader, judging, when judgment is made that the information reader is not installed in the computer, as to whether the computer program installed in the computer is equipped with an information reader function unit capable of accessing the content summary information based on the registered designating information, obtaining the content summary information and location information concerning information content included in the accessed content summary information, presenting the obtained content summary information to be viewed, and accessing the information content based on the obtained location information, activating, when judgment is made that the computer program installed in the computer is equipped with the information reader function unit, the information reader function unit in the computer program.

According to the above computer readable storage medium, when the information reader is installed in the computer, the computer can control the information reader to obtain the content summary information and present the obtained content summary information to be viewed by the user so that the user may manipulate the information reader and utilize the content summary information to access the information content.

### BRIEF DESCRIPTION OF THE ACCOMPANYING DRAWINGS

FIG. 1 is a block diagram to illustrate a network system according to an embodiment of the present invention.

FIG. 2 is illustrates RSS data to be used in the network system according to the embodiment of the present invention.

FIG. 3 is a flowchart to illustrate an installing operation in the network system according to the embodiment of the present invention.

### DETAILED DESCRIPTION

Hereinafter, an embodiment according to the present invention will be described with reference to the accompanying drawings.

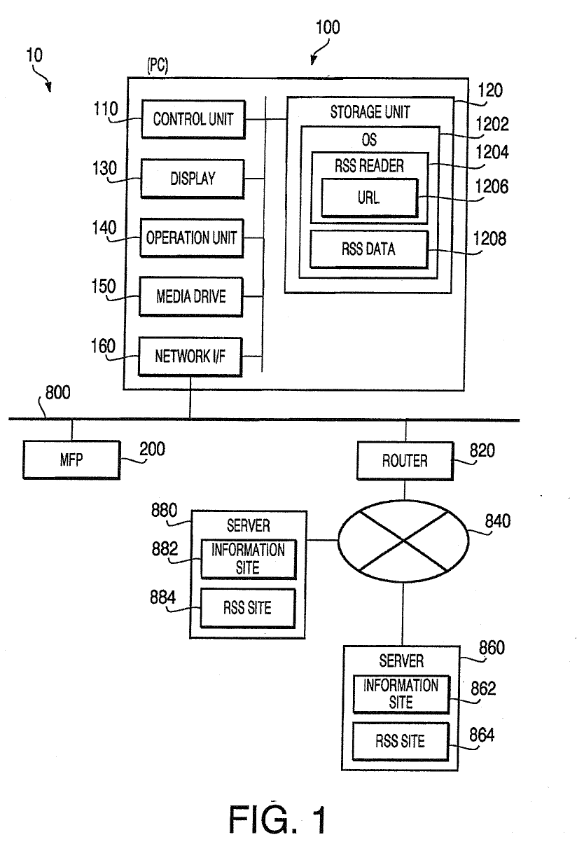

An overall configuration of a network system 10 according to the present embodiment will be described with reference to FIG. 1. The network system 10 includes a PC 100, a multi-functional peripheral (MFP) 200, and network devices (not shown), which are connected to one another through a local area network (LAN) 800 for data exchange. The MFP 200 is, for example, an image processing device to receive print data transmitted from the PC 100 and print an image according to the print data. Further, the MFP 200 can scan an image according to an instruction given by the PC 100 to generate image data and transmit the generated image data to the PC 100 through the LAN 800.

The LAN 800 is connected to the Internet 840 through a router 820. The Internet 840 is a network to which servers, such as a server 860 and a server 880, are connected. The PC 100 and the MFP 200 are connected to the Internet 840 through the LAN 800 and the router 820.

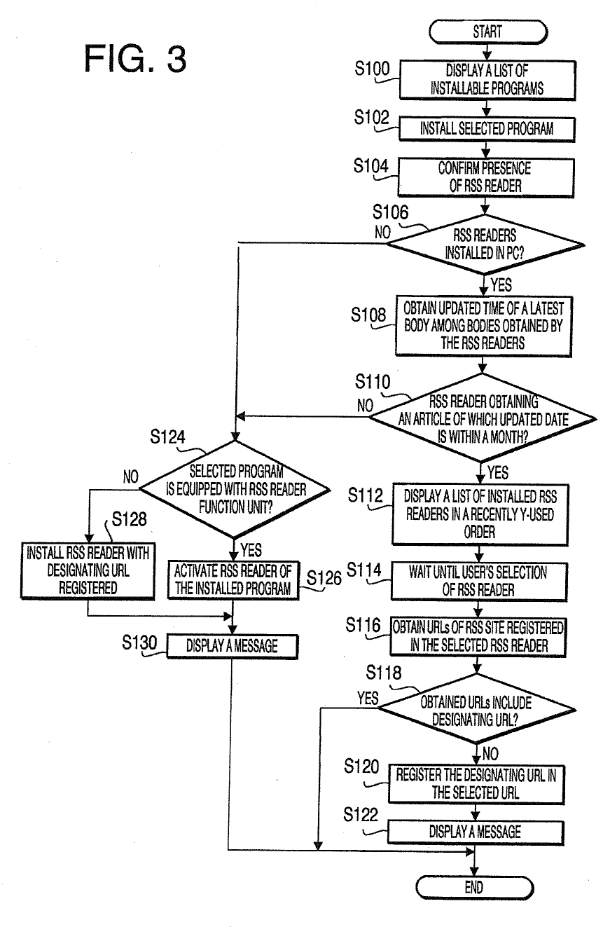

The server 860 provides a site 862, through which various information contents are published, to public, and the server 880 provides a site 882, through which various information contents are published, to public. The information contents include, for example, computer programs such as updating programs. Further, the server 860 provides an RSS site 864, and the server 880 provides an RSS site 884. The RSS sites 864, 884 provide RSS data, which is also referred to as RSS feed, concerning the information contents provided through the sites 862, 882, to RSS-requesting devices (e.g., the PC 100). In the present embodiment, the server 880 is offered by a supplier of a computer program, which controls an installing operation, and the RSS site 884 provided in the server 880 is also referred to as a summary information providing RSS site 884. The installing operation will be described later in detail with reference to FIG. 3.

A configuration of the PC 100 will be described. The PC 100 includes a controller unit 110, a storage unit 120, a display 130, an operation unit 140, a media drive 150, and a network interface (I/F) 160. The operation unit 140 is an input unit, which includes a keyboard and a mouse. The media drive 150 is a media drive device to read information written in memory media, such as a USB memory, a CD-R, and a DVD-R. The network I/F 160 provides an interface through which the PC 100 is connected to the LAN 800.

The controller unit 110 includes a CPU (not shown) to process arithmetic operations, a ROM to store various programs, and a RAM being a work area for the arithmetic operations. The storage unit 120 includes, for example, a hard disk drive (HDD). The storage unit 120 stores operating system (OS) 1202 and an RSS reader 1204, which obtains RSS data from the RSS sites 864, 884 on the Internet 840 and displays information based on the RSS data in the display 130. The storage unit 120 may store a plurality of RSS readers 1204, although solely one RSS reader 1204 is illustrated in the storage unit 120 of the PC 100 in FIG. 1. In the RSS reader 1204, URLs (Uniform Resource Locators) 1206 being location addresses of information sources, e.g., the RSS sites 864, 884, from which the RSS data is obtained, are registered by a user of the PC 100. For example, when the user wishes to obtain the RSS data from the RSS sites 864, 884, a URL 1206 indicating a location of the RSS site 864 and a URL 1206 indicating the RSS site 884 are registered in the RSS reader 1204. Thus, the RSS data distributed from the RSS sites 864, 884 is delivered to the RSS reader 1204.

In the storage unit 120, further, RSS data 1208 obtained by the RSS reader 1204 is stored. The RSS reader 1204 manages the RSS data 1208 obtained from the RSS sites 864, 884 and stored in the storage unit 120. The storage unit 120 may have a plurality of RSS readers 1204 installed. In this regard, the RSS readers 1204 manage the respectively-obtained RSS data 1208.

Moreover, the storage unit 120 stores driver programs (not shown) to drive a printer unit (not shown) and a scanner unit (not shown) of the MFP 200. Furthermore, a web browser is installed in the storage unit 120.

The CPU in the controller unit 110 accesses and activates the programs stored in the ROM and the programs 1202, 1204 stored in the storage unit 120 in the RAM to process necessary operations. For example, when the RSS reader 1204 stored in the storage unit 120 is activated, the RSS data distributed through the RSS sites 864, 884 is obtained. For another example, when an installer program to install a computer program (e.g., a status monitor to monitor behaviors of the MFP 200, a driver program, and other application programs) stored in a memory medium, which is set in the media drive 150, is activated, an installing operation to install the computer program in the PC 100 is activated. The installing operation will be described later in detail with reference to FIG. 3.

The MFP 200 includes a controller unit (not shown) with a CPU, a ROM, and a RAM, and a storage unit (not shown). Further, the MFP 200 includes a printer unit, a scanner unit, a monitor (not shown) to display information concerning operations in the MFP 200, an operation unit (not shown) being an input unit, through which a user's instruction can be entered, and a network I/F (not shown), which provides an interface to connect the MFP 200 to the LAN 800. Behaviors of the MFP 200 according to the present embodiment will be described later in detail.

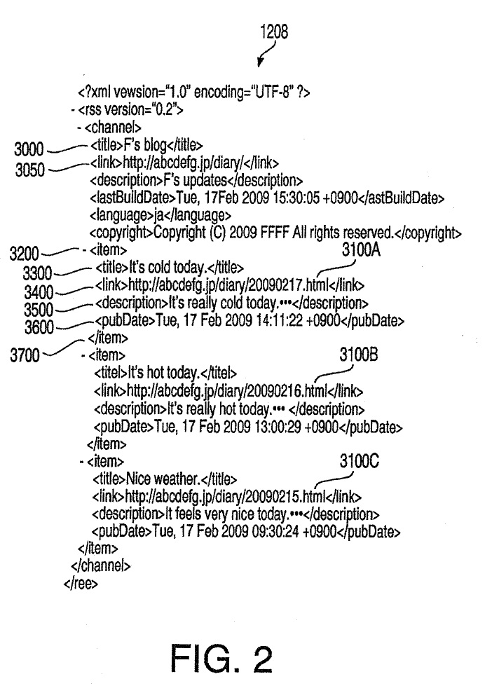

The RSS data 1208 to be obtained by the RSS reader 1204 according to the present embodiment will be described with reference to FIG. 2. The RSS data 1208 includes a main title 3000 (i.e., “F's blog”) of the RSS site being the source of the RSS data, a URL 3050 (i.e., “http://abcdefg.jp/diary/”) of the sites 862, 882, and other information concerning contents 3100A, 3100B, 3100C. The title 3000 of the RSS site is also used as a headline of the contents 3100A, 3100B, 3100C.

For example, the RSS data 1208 includes a content 3100A (i.e., “20090217.html”), which is described in between <item> tags 3200, 3700. The content 3100A includes a subhead 3300 (i.e., “It's cold today.”), a URL 3400 (i.e., “http://abcdefg.jp/diary/20090217.html”), and a body 3500 (i.e., “It's really cold today . . . ”), and updated time (i.e., Feb. 17, 2009, 14 (hour):11 (minute):22 (second)) 3600. The other contents 3100B, 3100C in the RSS data 1208 are in the same data structure as the content 3100A, and the body 3500 included in the content 3100A is a latest article amongst the bodies 3500 included in the contents 3100A, 3100B, 3100C in the RSS data 1208.

Next, an installing operation of a computer program according to the present embodiment will be described with reference to FIG. 3. The installing operation is activated when a computer readable storage medium storing an installer program is set in the media drive 150 by a user and the controller unit 110 develops the installer program in the RAM.

When the installer program is activated, in S100, the controller unit 110 displays a list of computer programs, which can be installed in the storage unit 120 of the PC 100, on a screen of the display 130. The user of the PC 100 is thus prompted to select one of the programs in the list. In this regard, if the list includes solely one installable program, the behavior in S100 can be omitted. Further the list may include a computer program, which can be provided, for example, through the site 882 in the server 880.

In S102, the controller unit obtains the selected computer program from the storage medium and develops in the RAM to install in the storage unit 120. If the user selects the computer program stored in the server 880, the controller unit 110 obtains a URL indicating the site 882 in the server 880 from the storage medium in the media drive 150, accesses the server 880 according to the URL, and manipulates a web browser and the network I/F 160 to download the selected computer program from the server 880.

In S104, the controller unit 110 examines as to whether the storage unit 120 has the RSS reader 1204 installed. In particular, the controller unit 110 accesses a database in the OS 1202, with which various kinds of operation settings concerning the PC 100 are registered, and confirms presence of the RSS reader 1204. The database is, for example, referred to as “registry” in Windows (registered trademark) OS manufactured by Microsoft Corporation.

In S106, the controller unit 110 judges as to whether the RSS reader 1204 is installed in the storage unit 120. If the RSS reader 1204 is installed (S106: YES), the flow proceeds to S105. If the RSS reader 1204 is not installed (S106: NO), the flow proceeds to S124.

In S108, the controller unit 110 obtains the updated time 3600 of the latest body 3500 amongst the bodies 3500 included in the RSS data 1208, which is stored in the storage unit 120, from each RSS reader 1204. When the storage unit 120 stores solely one RSS reader 1204, the updated time 3600 is obtained solely from the single RSS reader 1204. In S110, the controller unit 110 compares the updated time 3600 obtained from the RSS reader 1204 with current time and judges as to whether the updated time 3600 of the RSS data 1208 is within one month. The controller unit 110 examines all the updated times 3600 obtained from the RSS readers 1204 detected in S106. Thereafter, the controller unit 110 judges presence of the RSS reader 1204 with the RSS data 1208, of which updated time 3600 is within one month. If no RSS reader 1204 with the RSS data 1208, of which updated time 3600 is within one month, is found (S110: NO), the flow proceeds to S124. If an RSS reader 1204 with the RSS data 1208, of which updated time 3600 is within one month, is found (S110: YES), the flow proceeds to S112.

In S112, the controller unit 110 displays a list of RSS readers 1204 installed in the storage unit 120 on the screen of the display 130. In this regard, the RSS readers 1204 are presented to be selectable to the user. The controller unit 110 displays the RSS readers 1204 in a recently-used order, in which the RSS reader 1204 managing the RSS data with latest updated date 3600 comes on top and the RSS reader 1204 managing the RSS data with oldest updated date 3600 comes at bottom in the list. In S114, the controller unit 110 waits until the user selects one of the RSS readers 1204 in the list and enters the selection through the operation unit 140.

In S116, the controller unit 110 receives the selected RSS reader 1204 and retrieves the URLs 1206 registered in the selected RSS reader 1204 to reserve in the RAM. In S118, the controller unit 110 examines as to whether the retrieved URLs 1206 include a designating URL of the summary information providing RSS site 884. The designating URL indicates a location of the RSS site 884, which delivers specific RSS data (i.e., content summary information) specifically including information concerning the computer program installed in S102, and is written in the storage medium set in the media drive 150 to be referred to by the controller unit 110.

If the URLs 1206 retrieved in S116 includes the designating URL, in other words, if the designating URL is registered in the selected RSS reader 1204 (S118: YES), the flow is ended, and no further designating URL is registered. If the designating URL is not registered in the selected RSS reader 1204 (S118: NO), in S120, the controller unit 110 registers the designating URL with the selected RSS reader 1204.

In S122, a message indicating outcome of the operations is displayed on the screen of the display 130. In particular, the message indicates that: the selected computer program is installed in the storage unit 120 (see S102) without failure; the designating URL is registered in the selected RSS reader 1204 (see S120); and the content summary information concerning the computer program installed in S102 can be hence obtained by the RSS reader 1204 to be viewed by the user. The flow is ended thereafter. The information to be included in the content summary information is, for example, an article concerning updates of the computer program and an article describing a new product supplied by the provider of the server 880.

If negative judgment is made in S106 (S106: NO) or in S110 (S110: NO), in S124, the controller unit 110 examines to judge as to whether the computer program selected by the user after S100 and installed in S102 is equipped with an RSS reader function unit. If the computer program is equipped with the RSS reader function unit (S124: YES), in S126, the controller unit 110 activates the RSS reader function of the computer program. The flow proceeds to S130. According to the present embodiment, the computer program equipped with the RSS reader function unit has the designating URL registered preliminarily.

In S124, if the computer program is not equipped with the RSS reader function unit (S124: NO), in S128, the controller unit 110 newly installs RSS reader with the designating URL registered in the storage unit 120. The flow proceeds to S130. The newly installed RSS reader will behave as the RSS reader 1204 in the PC 100 as illustrated in FIG. 1.

In S130, a message indicating outcome of the operations is displayed on the screen of the display 130.

In particular, the message indicates that the selected computer program is installed in the storage unit 120 (see S102) and information concerning the operation in S126 or S128. For example, when the RSS reader function in the computer program was activated in S126, the message in S130 indicates the activation of the RSS reader function and that the content summary information concerning the computer program installed in S102 can be hence obtained by the RSS reader 1204 to be viewed.

For another example, when the RSS reader with the designating URL registered was newly installed in S128, the message in S130 indicates that: the RSS reader 1204 was installed in the storage unit 120; and the content summary information concerning the computer program installed in S102 can be hence obtained by the newly installed RSS reader 1204 to be viewed. The flow of the installing operation is ended thereafter.

In the above operation flow, the behavior of the controller unit 110 in S126 or in S128 following negative judgment in S106 or in S108 enables the PC 100 to provide the information concerning the computer program included in the content summary information to the user even when the PC 100 does not have the RSS reader 1204 installed (S106: NO) or the RSS reader 1204 installed in the PC 100 has not been utilized (S110: NO).

According to the installing operation, the designating URL indicating the location of the content summary information providing site, i.e., the RSS site 884, which distributes the content summary information, can be registered in the RSS reader 1204 installed in the PC 100 upon installation of the computer program. Therefore, the PC 100 can obtain the content summary information, i.e., the RSS data 1208, which may be useful to the PC 100 and the user. The content summary information concerning the computer program includes information directly or indirectly related to the computer program. The information indirectly related to the computer program includes, for example, information concerning a supplier of the computer program. The content summary information obtained by the RSS reader 1204 can be presented to the user to view through, for example, the display 130.

According to the installing operation, when the RSS reader 1204 is installed in the PC 100, the controller unit 110 can control the RSS reader 1204 to obtain the content summary information and present the obtained content summary information to be viewed by the user so that the user may manipulate the RSS reader 1204 and utilize the content summary information to access the information content.

Although an example of carrying out the invention has been described, those skilled in the art will appreciate that there are numerous variations and permutations of the a computer readable storage medium containing computer readable instructions that fall within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims.

Examples of variations of the installer program will be described. In the above embodiment, in order to obtain the content summary information from the RSS sites 864, 884, the URLs 1206 of the RSS sites 864, 884 are registered in the RSS reader 1204. Instead, the main titles 3000 of the RSS sites 864, 884 may be registered in the RSS reader 1204 in association with the URLs 1206 of the RSS sites 864, 884. According to the configuration, when the user refer to the information registered in the RSS reader, the user can recognize the registered RSS sites 864, 884 based on the registered main titles 3000, which may represent the registered RSS sites 864, 884 more recognizably.

In the above embodiment, when the computer program installed in the storage unit 120 in S102 includes the RSS reader function unit, the designating URL, indicating the location of the content summary information concerning the installed computer program, is registered preliminarily in the RSS reader function unit. Instead, for example, the computer program may be installed without the designating URL, and the designating URL may be registered in the RSS reader installed along with the computer program after the installation. When the designating URL is registered after the installation of the computer program, the designating URL in the storage medium set in the media drive 150 is referred to by the controller unit 110 and written in the RSS reader 1204 in the storage unit 120.

In the above embodiment, if negative judgment is made in S110 in the installing operation (S110: NO), the controller unit 110 avoids flow S112-S122. However, the flow S112-S122 may be executed, for example, following the flow S124-S130 even after the negative judgment is made in S110.

In the above embodiment, the RSS readers 1204 in the storage unit 120 are listed in the recently-used order, in which the RSS reader 1204 managing the RSS data with latest updated date 3600 comes on top and the RSS reader 1204 managing the RSS data with oldest updated date 3600 comes at bottom. However, the RSS readers 1204 may not necessarily listed in the recently-used order, but may be listed in a different order based on different conditions. For example, the RSS readers 1204 may be listed in a recently-viewed order, in which the RSS reader 1204 managing the RSS data with the body 3500 most recently viewed by the user comes on top and the RSS reader 1204 managing the RSS data with the body 3500 having the oldest viewed data comes at bottom. For another example, the RSS readers 1204 may be listed in a recently-activated order, in which the RSS reader 1204 having been activated by the user most recently comes on top. Further, the RSS readers 1204 may be listed in a descending order of numbers of the bodies 3500 having been viewed.

In the above embodiment, prior to judgment in S118 in the installing operation, the designating URL is obtained from the memory medium set in the media drive 150 to be compared with the URLs 1206 registered in the RSS reader 1204 and obtained in S116. Instead, the controller unit 110 may communicate with the server 880 to obtain the designating URL therefrom.

In the above embodiment, the content summary information including information concerning the computer program being installed in the PC 100 is in the RSS-format; however, a format of the content summary information is not limited to the RSS, but may be, for example, Atom.

What is claimed is:

1. A computer readable storage medium storing computer readable instructions that manipulate a computer to install a computer program by executing steps of:
installing a computer program in the computer; and
registering designating information indicating a location of a content summary information providing site, through which content summary information concerning the computer program is distributed, in an information reader, which is capable of accessing the content summary information based on the registered designating information, obtaining the content summary information and location information concerning information content included in the accessed content summary information, and accessing the information content based on the obtained location information, so that the information reader obtains the content summary information concerning the installed computer program based on the registered designating information.

2. The computer readable storage medium according to claim 1,
wherein the designating information is not registered in the information reader if the designating information has been registered in the information reader.

3. The computer readable storage medium according to claim 1,
wherein the installed computer program is equipped with the information reader; and
wherein the steps to install the computer program further include activating the information reader in the computer program.

4. The computer readable storage medium according to claim 1,
wherein the information reader obtains predetermined content summary information through a predetermined content summary information providing site;
wherein the installed computer program is equipped with the information reader; and
wherein the designating information is registered in the information reader in the installed computer program so that the information reader obtains the predetermined content summary information based on the designating information.

5. The computer readable storage medium according to claim 1,
wherein the steps to install the computer program further include:
examining oldness of an article included in the content summary information obtained by the information reader to judge as to whether an information reader having obtained an article, of which oldness is within a predetermined period, is installed in the computer;
judging, when judgment is made that the information reader having obtained the article, of which oldness is within the predetermined period, is not installed in the computer, as to whether the computer program installed in the computer is equipped with an information reader function unit capable of accessing the content summary information based on the registered designating information, obtaining location information concerning information content included in the accessed content summary information, and accessing the information content based on the obtained location information; and
activating, when judgment is made that the computer program is equipped with the information reader function unit, the information reader function unit in the computer program.

6. The computer readable storage medium according to claim 5,
wherein the oldness of the article included in the content summary information obtained by the information reader is examined by comparing a latest updated date of the article with current time.

7. The computer readable storage medium according to claim 1,
wherein the information reader includes an RSS reader, and the content summary information includes RSS-formatted data.

8. A computer readable storage medium storing computer readable instructions that manipulate a computer to install a computer program by executing steps of:
installing a computer program in the computer;
judging as to whether an information reader, which is capable of accessing content summary information concerning the computer program based on registered designating information, obtaining location information concerning information content included in the accessed content summary information, and accessing the information content based on the obtained location information, is installed in the computer;
registering, when judgment is made that the information reader is installed in the computer, the designating information indicating a location of a content summary information providing site, through which the content summary information is provided to the computer, in the information reader;
judging, when judgment is made that the information reader is not installed in the computer, as to whether the computer program installed in the computer is equipped with an information reader function unit capable of accessing the content summary information based on the registered designating information, obtaining the content summary information and location information concerning information content included in the accessed content summary information, presenting the obtained content summary information to be viewed, and accessing the information content based on the obtained location information;
activating, when judgment is made that the computer program installed in the computer is equipped with the information reader function unit, the information reader function unit in the computer program.
